(19) United States
(12) Patent Application Publication
(10) Pub. No.: US 2014/0356714 A1
(43) Pub. Date: Dec. 4, 2014

(54) PROCESS FOR PREPARING A CORE-SHELL STRUCTURED LITHIATED MANGANESE OXIDE

(71) Applicants: Roger Zhou, Changning (CN); Yongyao Xia, Changning (CN); Rongrong Jiang, Changning (CN); Yonggang Wang, Changning (CN); Wangjun Cui, Changning (CN); Yuqian Dou, Changning (CN); Long Chen, Changning (CN)

(72) Inventors: Roger Zhou, Changning (CN); Yongyao Xia, Changning (CN); Rongrong Jiang, Changning (CN); Yonggang Wang, Changning (CN); Wangjun Cui, Changning (CN); Yuqian Dou, Changning (CN); Long Chen, Changning (CN)

(73) Assignee: ROBERT BOSCH GMBH, Stuttgart (DE)

(21) Appl. No.: 14/372,647

(22) PCT Filed: Jan. 16, 2012
(86) PCT No.: PCT/CN2012/070408

§ 371 Date: Jul. 16, 2014

(51) Int. Cl. H01M 4/04; H01M 4/36; H01M 4/505

(52) U.S. Cl. CPC H01M 4/0471; H01M 4/505; H01M 4/366; H01M 4/049; H01M 4/0402
USPC 429/220; 427/215; 429/224

(57) ABSTRACT

The invention relates to a process for preparing a core-shell structured lithiated manganese oxide, comprising the steps of providing spinel LiMₓMn₂₋ₓO₄ particles, where M is one or more metal ions selected from the group consisting of Li, Mg, Cr, Al, Co, Ni, Zn, Cu, and La, and 0≦x<1, as core particles, and subjecting the spinel particles to a heat-treatment with a reactive chemical reagent in the form of liquid or gas to form a shell layer on the surface of the core particles, and to the prepared core-shell structured lithiated manganese oxide, and its use as a cathode material for a lithium ion battery

### BACKGROUND OF THE INVENTION

The invention relates to a process for preparing a core-shell structured lithiated manganese oxide, the prepared core-shell structured lithiated manganese oxide and its use as a cathode material for a lithium ion battery.

In view of the economic and environmental advantages over commercially available LiCoO₂, spinel LiMn₂O₄ is a potentially attractive alternative cathode material for lithium-ion batteries, especially for large-scale batteries. However, the spinel LiMn₂O₄ suffers from severe capacity fading on cycling, especially at elevated temperatures. The cycling stability of the spinel has been improved by two main categories of approaches: ion doping to stabilize its crystal structure and surface coating to prevent Mn dissolution. It has been demonstrated that Mn dissolution increases with contact area of the spinel with electrolyte. Typically, sol-gel method and precipitation method are used for metal oxides surface coating.

Kenneth A. Walz et al., in “Elevated temperature cycling stability and electrochemical impedance of LiMn₂O₄ cathodes with nanoporous ZrO₂ and TiO₂ coatings”, Journal of Power Sources, 195 (2010) 4943-4951, describes coating LiMn₂O₄ cathodes with ZrO₂ and TiO₂ by using sol-gel technique.

Xifei Li et al, in “Enhanced cycling performance of spinel LiMn₂O₄ coated with ZnMn₂O₄ shell”, Journal of Solid State Electrochem, (2008) 12: 851-855, describes coating spinel LiMn₂O₄ with ZnMn₂O₄ shell by mixing LiMn₂O₄ and ZnO in the ball mill, and calcining the mixed powders.

These methods can reduce the contact area of the spinel with electrolyte and improve cycling stability of the material to a certain extent. However, the resulting coating layers are not uniform and continuous. Instead, there are isolated nano-sized metal oxide particles attached on the surface of spinel particles. The improvement in the cycling performance of the obtained spinel is not satisfactory.

Therefore, there still remains a need for a more useful method for forming a uniform and continuous layer on the surface of spinel particles, to obtain a lithiated manganese oxide material, which exhibits significantly improved cycling stability at elevated temperatures.

### SUMMARY OF THE INVENTION

According to one aspect of the present invention, there is provided a process for preparing a core-shell structured lithiated manganese oxide, comprising the steps of providing spinel LiMₓMn₂₋ₓO₄ particles, where M is one or more metal ions selected from the group consisting of Li, Mg, Cr, Al, Co, Ni, Zn, Cu, and La, and 0≦x≦1, as core particles, and subjecting the spinel particles to a heat-treatment with a chemical reagent reactive towards the spinel LiMₓMn₂₋ₓO₄ particles in the form of liquid or gas to form a continuous and uniform shell layer on the surface of the core particles.

According to another aspect of the present invention, there is provided a core-shell structured lithiated manganese oxide obtainable by the process according to the present invention.

According to a further aspect of the present invention, there is provided a cathode material for a lithium ion battery comprising the core-shell structured lithiated manganese oxide.

According to a further aspect of the present invention, there is provided a lithium ion battery comprising the core-shell structured lithiated manganese oxide as cathode material.

### BRIEF DESCRIPTION OF THE DRAWINGS

FIG. 1 is SEM image of the core-shell structured lithiated manganese oxide prepared according to Example 1.

FIG. 2 is TEM image of the core-shell structured lithiated manganese oxide prepared according to Example 1.

FIG. 3 is a graph showing comparison of the charge/discharge curves at 60° C. of LiMn₂O₄ with (according to Example 1) and without P₂O₅ treatment.

FIG. 4 is graph showing comparison of the cycling stability at 60° C. of LiMn₂O₄ cathode materials with (according to Example 1) and without P₂O₅ treatment.

### DETAILED DESCRIPTION

In one aspect, the present invention provides a process for preparing a core-shell structured lithiated manganese oxide. The process comprises the steps of:

providing spinel LiMₓMn₂₋ₓO₄ particles, where M is one or more metal ions selected from the group consisting of Li, Mg, Cr, Al, Co, Ni, Zn, Cu, and La, and 0≦x≦1, as core particles, and subjecting the spinel particles to a heat-treatment with a chemical reagent reactive towards the spinel particles in the form of liquid or gas, to form a continuous and uniform shell layer on the surface of the core particles.

The spinel LiMₓMn₂₋ₓO₄ particles, where 0≦x≦1, are commercially available products, or can be prepared by any suitable methods known to a person skilled in the art, such as solid-state reaction method, and co-precipitation method. In a preferred embodiment, the spinel LiMₓMn₂₋ₓO₄ particles are prepared by a solid-state reaction of a stoichiometric mixture of a lithium compound, a manganese compound, and, if appropriate, a compound of M by heat treating. In the solid-state reaction process, the compounds, used as the precursors of the respective metals of lithium, manganese and M, are mixed under ball milling, and heat treated at a temperature of preferably 650° C. for 5 h in air, and then cooled. The thus-obtained product is further calcinated at a temperature of 900° C. for 10 h in air, and then cooled to room temperature.

As the respective precursors of Li, Mn and M, the lithium compound, the manganese compound and the compound of M are not particularly restricted, and examples thereof may include carbonates, nitrates, hydroxides, oxides of Li, Mn and M. Preferably, lithium carbonate, manganese oxide, and oxide of M are used.

The spinel LiMₓMn₂₋ₓO₄ particles are then subjected to a heat-treatment with a chemical reagent reactive towards the spinel particles in the form of liquid or gas. The heat-treatment can be performed at a temperature of from 100 to 800° C. for 0.5˜5 h.

By the heat-treatment, the spinel LiMₓMn₂₋ₓO₄ particles react with the liquid or gaseous reactive chemical reagent, to form a continuous and uniform shell layer on the surface of the spinel particles.

As known to a person skilled in the art, spinel LiMₓMn₂₋ₓO₄ suffers from Jahn-Teller distortion during charging-discharging process, which induces disproportion reaction of unstable Mn³⁺ with acid in electrolyte, and the reaction may be further enhanced at elevated temperature. The inventor has found that after treatment with the chemical reagent that can react with the spinel LiMₓMn₂₋ₓO₄, a uniform and continuous layer is formed on the particle surface, and this protective layer, which is not spinel structure, would not suffer from Jahn-Teller distortion. Moreover, it can significantly reduce the contact area of the core with the electrolyte, and thus effectively reduce Mn dissolution into the electrolyte solution.

The reactive chemical reagent is preferably selected from NH₃, P₂O₅, and triphenyl phosphine.

In an embodiment of the invention, NH₃ is used as the chemical reagent. Preferably, NH₃ gas flow at a rate of 0.01˜1 L/min, preferably 0.01˜0.05 L/min is introduced to the spinel particles. In this embodiment, the heat-treatment is performed at a temperature of from 650 to 750° C. for 0.5˜5 h. It is contemplated that a shell layer of manganese nitride is coated on the surface of the spinel particles.

In a further embodiment of the invention, P₂O₅ is used as the chemical reagent. Preferably, the spinel particles and P₂O₅ powders are mixed in a weight ratio of from 10:1 to 50:1. In this embodiment, the heat-treatment is performed at a temperature of from 550 to 650° C. for 0.5˜2 h. It is contemplated that a shell layer of lithium manganese phosphate is coated on the surface of the spinel particles.

In a still further embodiment of the invention, triphenyl phosphine is used as the chemical reagent. Preferably, the spinel particles and triphenyl phosphine powders are mixed in a weight ratio of from 10:1 to 50:1. In this embodiment, the heat-treatment is performed at a temperature of from 150 to 250° C. for 0.5˜5 h. It is contemplated that a shell layer of manganese phosphate is coated on the surface of the spinel particles.

The thus-obtained lithiated manganese oxide has a core-shell structure. The core consists of spinel LiMₓMn₂₋ₓO₄ particles, where M is one or more metal ions selected from the group consisting of Li, Mg, Cr, Al, Co, Ni, Zn, Cu, and La, and 0<x<1. The shell, which is not spinel structure, has a Mn-containing composition, and is produced through the reaction between the spinel LiMₓMn₂₋ₓO₄ particles and the reactive chemical reagent. The shell has a thickness of 5-20 nm.

The core-shell structured lithiated manganese oxide has a uniform and continuous layer formed on the surface of the spinel lithiated manganese oxide. The protective layer can significantly reduce the contact area of the spinel with the electrolyte, thus effectively preventing Mn dissolution into the electrolyte solution, and thereby improving the cycling performance of the lithiated manganese oxide.

The core-shell structured lithiated manganese oxide according to the invention can be advantageously used as a cathode material for a lithium-ion battery. The oxide exhibits an improved cycling stability, especially at elevated temperatures.

The following examples further illustrate the process according to the invention, and the characteristics of the prepared compound used as cathode material for lithium ion battery. The examples are given by way of illustration only, and are not intended to limit the invention in any manner.

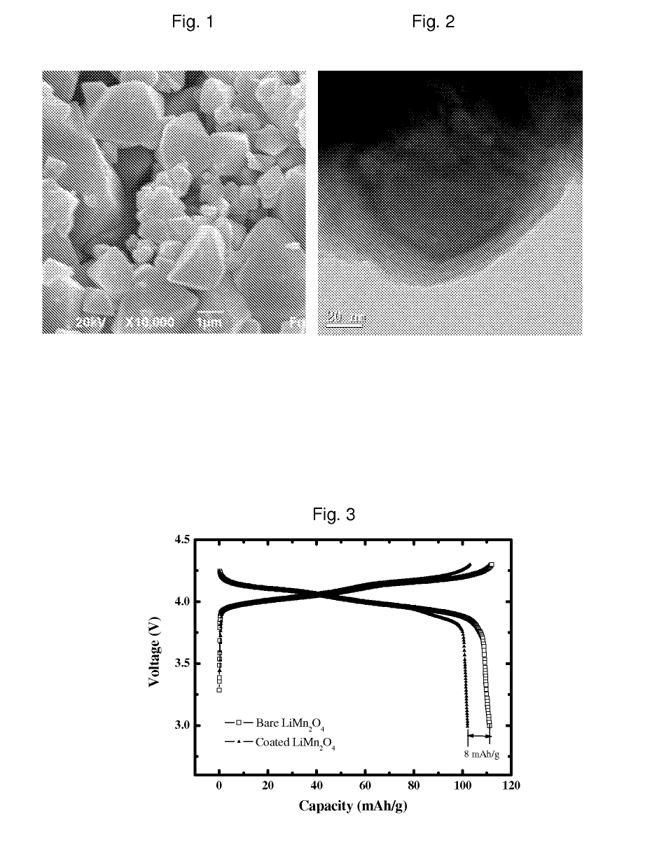

LiMn₂O₄ powder was mixed with P₂O₅ powder in a weight ratio of 10:1, and the mixture was heat treated at 600° C. for 1 hour in a sealed reactor. The SEM and TEM images of the resulting compound indicated that a shell layer with a thickness of 10-20 nm was continuously and uniformly coated on the lithiated manganese oxide particles (FIG. 1 and FIG. 2).

### Example 2

LiMn₂O₄ powder was treated with NH₃ at a flow rate of 0.02 L/min at 700° C. for 1 hour in a sealed reactor. A shell layer with a thickness of 10-20 nm was continuously and uniformly coated on the lithiated manganese oxide particles.

### Example 3

LiMn₂O₄ powder was mixed with triphenyl phosphine powder in a weight ratio of 10:1, and the mixture was heat treated at 200° C. for 1 hour in a sealed reactor. A shell layer with a thickness of 10-20 nm was continuously and uniformly coated on the lithiated manganese oxide particles.

### Example 4

Spinel LiLi_{0.1}Mn_{1.9}O₄ was Prepared by a Solid-State Reaction Process:

A stoichiometric amount of reagent grade Li₂CO₃ (commercial battery class, micro-size), MnO₂ (commercial product) were mixed by ball-milling. The mixture were heat treated at 650° C. for 5 h in air, cooled and mixed again, and then further calcinated at 900° C. for 10 h in air, cooled slowly to 600° C. and finally cooled to room temperature.

The resulting Li_{1.1}Mn_{1.9}O₄ powder was mixed with P₂O₅ in a weight ratio of 30:1. A heat-treatment was conducted at 600° C. in a hermetic reactor for 2 hours. A shell layer with a thickness of 10-20 nm was continuously and uniformly coated on the spinel particles.

Cell Assembling and Electrochemical Tests:

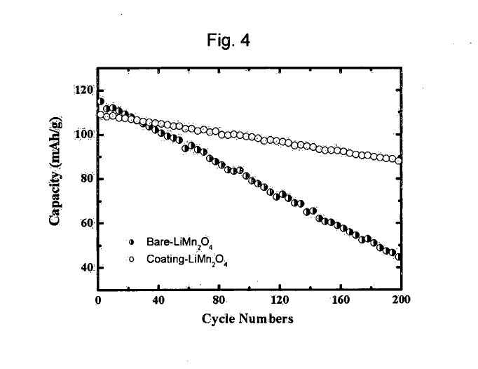

The electrochemical performances of the spinel LiMn₂O₄ with P₂O₅ treatment according to Example 1 and a spinel LiMn₂O₄ without P₂O₅ treatment as a control were tested using R2016-type coin cells. The working electrode was prepared by pasting a slurry mixture of 90 wt % of the active material, 4 wt % of carbon black, 1 wt % of KS-6 and 5 wt % PVdF1 in NMP solvent on an aluminum foil. After coating the mixture on aluminum foil, the electrode was dried at 120° C. in vacuum for 12 h. The R2016-type coin cell was assembled in a glove box with H₂O and O₂ less than 1 ppm using 1M LiPF₆ in EC-DMC-EMC3 (1:1:1 by volume) as the electrolyte, the spinel oxide electrode as the positive electrode, and Li metal as the negative electrode. The cycling performances were evaluated by using LAND cycler/Arbin battery testing system to charge/discharge cells in the potential range of 3-4.3 V, with the current density for charge/discharge test and cycling test being 1/3 C. The test results are shown in FIG. 3 and FIG. 4.

FIG. 3 is a graph showing comparison of the charge/discharge curves at 60° C. of LiMn₂O₄ with (according to Example 1) and without P₂O₅ treatment (control). FIG. 4 is graph showing comparison of the cycling stability at 60° C. of LiMn₂O₄ cathode materials with (according to Example 1) and without P₂O₅ treatment (control).

As shown in FIG. 4, the capacity retention of the treated spinel after 200 cycles was about 82% at 60° C.; while the capacity retention of the untreated spinel after 200 cycles was much smaller (about 50%). From FIG. 3 and FIG. 4, it can be seen that the treated spinel LiMn₂O₄ particles according to the invention exhibit significantly improved cycling stability at elevated temperature of 60° C., while the capacity is reduced only by as little as 8 mAh/h, compared to the untreated spinel LiMn₂O₄.

What is claimed is:

1. A process for preparing a core-shell structured lithiated manganese oxide, comprising the steps of providing spinel LiMₓMn₂₋ₓO₄ particles, where M is one or more metal ions selected from the group consisting of Li, Mg, Cr, Al, Co, Ni, Zn, Cu, and La, and 0≦x≦1, as core particles, and subjecting the spinel particles to a heat-treatment with a chemical reagent reactive towards the spinel LiMₓMn₂₋ₓO₄ particles in the form of liquid or gas to form a continuous and uniform shell layer on the surface of the core particles, wherein the shell is not spinel structure.

2. The process according to claim 1, wherein, the spinel LiMₓMn₂₋ₓO₄ particles are prepared by a solid-state reaction of a stoichiometric mixture of a lithium compound, a manganese compound, and, if appropriate, a compound of M by heat treating.

3. The process according to claim 2, wherein, the lithium compound is selected from the group consisting of lithium carbonates, lithium nitrates, lithium hydroxides, and lithium oxides.

4. The process according to claim 2, wherein, the manganese compound is selected from the group consisting of manganese carbonates, manganese nitrates, manganese hydroxides, and manganese oxides.

5. The process according to claim 2, wherein, the compound of M is selected from the group consisting of carbonates, nitrates, hydroxides, and oxides of M.

6. The process according to any one of claims 1 to 5, wherein, the heat-treatment is performed at a temperature of from 100 to 800° C. for 0.5˜5 h.

7. The process according to any one of claims 1 to 6, wherein, the chemical reagent is selected from the group consisting of NH₃, P₂O₅, and triphenyl phosphine.

8. The process according to claim 7, wherein, NH₃ is used as the chemical reagent, and the heat-treatment is performed at a temperature of from 650 to 750° C. for 0.5˜5 h.

9. The process according to claim 7, wherein, P₂O₅ is used as the chemical reagent, and the heat-treatment is performed at a temperature of from 550 to 650° C. for 0.5˜2 h.

10. The process according to claim 7, wherein, triphenyl phosphine is used as the chemical reagent, and the heat-treatment is performed at a temperature of from 150 to 250° C. for 0.5˜5 h.

11. A core-shell structured lithiated manganese oxide prepared by the process according to any one of claims 1 to 10.

12. The core-shell structured lithiated manganese oxide according to claim 11, wherein, the shell has a thickness of 5-20 nm.

13. A cathode material for a lithium ion battery comprising the core-shell structured lithiated manganese oxide according to any one of claims 11 to 12 or prepared by the process according to any one of claims 1 to 10.

14. A lithium ion battery comprising the core-shell structured lithiated manganese oxide according to any one of claims 11 to 12 or prepared by the process according to any one of claims 1 to 10 as a cathode material.
